(19) United States
(12) Patent Application Publication
(10) Pub. No.: US 2025/0069334 A1
(43) Pub. Date: Feb. 27, 2025

(54) Assisted Scene Capture for an Artificial Reality Environment

(71) Applicant: Meta Platforms Technologies, LLC, Menlo Park, CA (US)

(72) Inventors: Sony NGUYEN, San Jose, CA (US); Justin STRAWN, San Francisco, CA (US); Eric LEUNG, San Francisco, CA (US); Marc KREJCI, North Bend, WA (US); Benjamin XU, San Mateo, CA (US); Samuel MCGAREY, Mountain View, CA (US); Muqing NIU, Issaquah, WA (US); Sierra DEAN, Mountain View, CA (US); Jianhan XU, Vancouver (CA); Ran ZHANG, San Mateo, CA (US); Lu ZHOU, San Francisco, CA (US); Audrey Muller, San Francisco, CA (US); Matthew Banks, Kirkland, WA (US); Sabrina Zhai, New York, NY (US)

(21) Appl. No.: 18/454,349

(22) Filed: Aug. 23, 2023

(51) Int. Cl. G06T 19/00

(52) U.S. Cl. CPC G06T 19/006

(57) ABSTRACT

Aspects of the present disclosure are directed to providing assisted scene capture for an artificial reality (XR) environment. Some implementations can obtain an XR space model corresponding to a real-world space, including walls, the ceiling, and the floor, using an XR system. Some implementations can then scan the real-world space and display a mesh corresponding to the scanned area overlaid onto a view of the real-world space. Some implementations can perform post-processing on the displayed mesh, which can include A) collapsing variations in the mesh corresponding to the walls, ceiling, or floor onto the XR space model; B) clipping the mesh to the XR space model for open doorways, windows, etc.; C) simplifying the mesh corresponding to the walls, ceiling, or floor; D) determining that the mesh is complete by identifying that a threshold percentage of the XR space model is covered by the mesh; or any combination thereof.

### TECHNICAL FIELD

The present disclosure is directed to improved scene capture of a real-world environment for use in an artificial reality (XR) environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive 3D experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a lens to combine with light from a waveguide that simultaneously emits light from a projector in the MR HMD, allowing the MR HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing assisted scene capture for an artificial reality environment.

FIG. 6 is a flow diagram illustrating a process used in some implementations for locally applying and updating a trained model for generating depth predictions according to some implementations of the present technology.

FIG. 7 is a block diagram illustrating an overview of a machine learning system that can be applied to generate depth predictions according to some implementations of the present technology.

FIG. 8 is a conceptual diagram illustrating an exemplary real-world space being automatically scanned to generate a room box according to some implementations of the present technology.

FIG. 9A illustrates an exemplary view on an artificial reality device of an artificial reality overlay instructing a user to outline a wall in a real-world space in order to generate a room box.

FIG. 9B illustrates an exemplary view on an artificial reality device of a user outlining a wall in a real-world space using a controller in order to generate a room box.

FIG. 10A illustrates an exemplary view on an artificial reality device of a mesh being displayed as the artificial reality device scans a real-world space.

FIG. 10B illustrates an exemplary view on an artificial reality device of a mesh being collapsed to a room box in post-processing based on a minor variation in the mesh.

FIG. 10C illustrates an exemplary view on an artificial reality device of a mesh extending into an open doorway being clipped to a room box in post-processing.

FIG. 10D illustrates an exemplary view on an artificial reality device of a mesh being simplified where it corresponds to the identified walls, ceiling, and floor in a real-world space.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to assisted scene capture of a real-world environment for use in an artificial reality (XR) environment. Some types of artificial reality incorporate real-world elements, such as real-world rooms and spaces, by digitally reconstructing or capturing those elements as a three-dimensional (3D) space or an XR space. In addition to capturing the elements, it is necessary to align the XR space to the corresponding real-world space so that the location where a user is viewing in the XR space is approximately the same location in the real-world space.

Thus, some implementations can provide an assisted scene capture system that can use cameras and depth sensors integrated in an XR device to scan the world surrounding a user, in order to generate a 3D model of the world using computer vision. The assisted scene capture system can initially generate a room box (referred to interchangeably herein as an “XR space model”) for the user's world that can be adjusted by the user to indicate where the walls, floor, and ceiling exist. Then, the assisted scene capture system can scan the real-world environment (including physical objects in the world), displaying a mesh corresponding to the scanned area while the user looks and moves about the world.

The assisted scene capture system can use the room box to generate the mesh in multiple ways: A) using the room box as ground truth for large, flat spaces (e.g., collapsing minor variations in the mesh identified in the walls, ceiling, and floor onto the room box; and clipping the mesh to the room box where windows, open doorways, etc. result in the mesh extending beyond the walls); B) for the identified walls, ceiling, and floor of the room box, simplifying the triangles representing the scanned area, resulting in fewer processing resources being used to generate, and later use, the mesh; and C) identifying whether a threshold percentage of the room box is covered by the mesh to determine whether the mesh is sufficiently complete. Once generated, the room box and the mesh can be provided to XR applications, which can opt to use either. For example, using the mesh, the XR application can display a virtual ball bouncing off not only the walls and floor, but also objects in the real-world environment of the user.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Implementations described herein provide specific technological improvements in the field of artificial reality. In some implementations, by clipping a scanned mesh to a room box where it extends into windows, glass doors, etc., a more realistic experience can be provided, as described herein. The experience can be similarly improved by ensuring that a threshold amount of the room box is covered by the mesh, such that executed XR applications can maximize utilization of the corresponding real-world space in XR experiences. Some implementations can further simplify the mesh by reducing its size, reducing the level of detail in the mesh for flat surfaces, and/or by removing minor variations in the mesh, without affecting the user experience. Such simplification can result in less storage space needed for the mesh (locally and/or on a cloud), less memory needed to utilize the mesh in XR applications, improved latency, and faster processing speeds on an XR device.

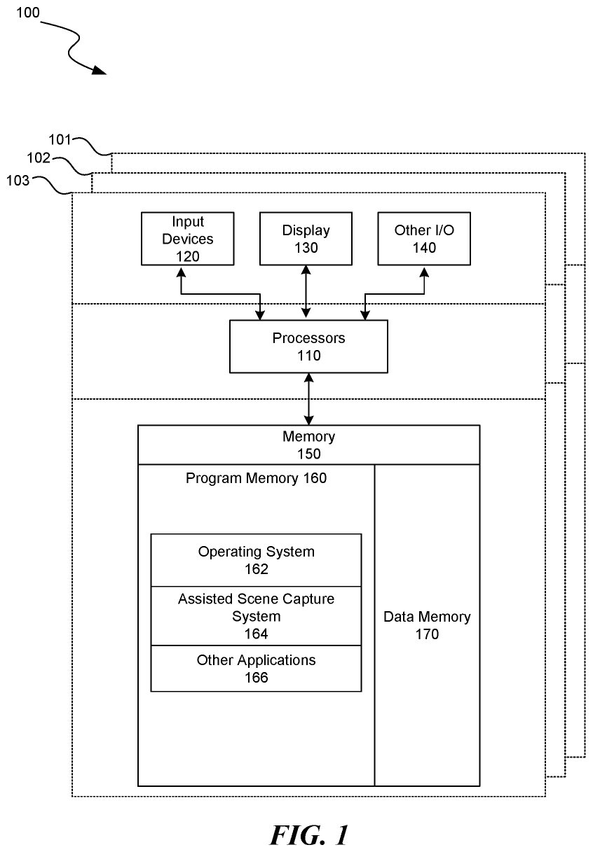

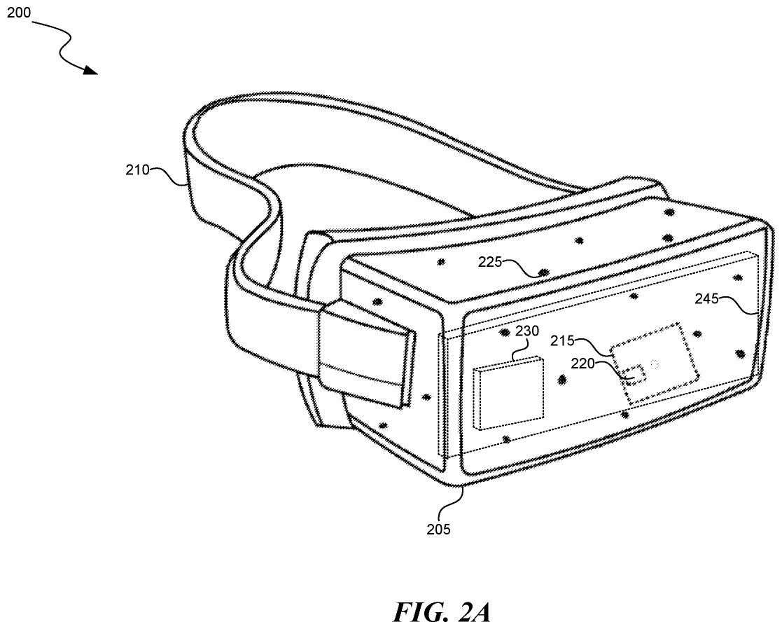

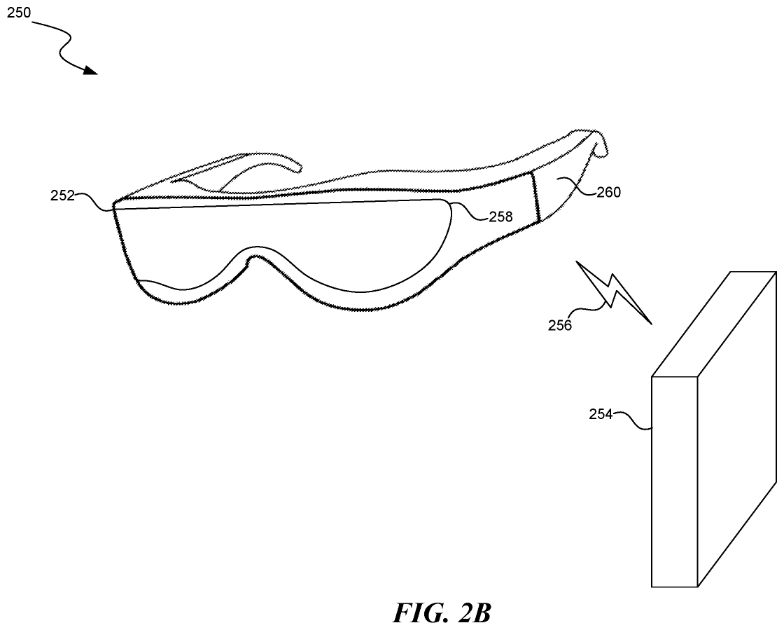

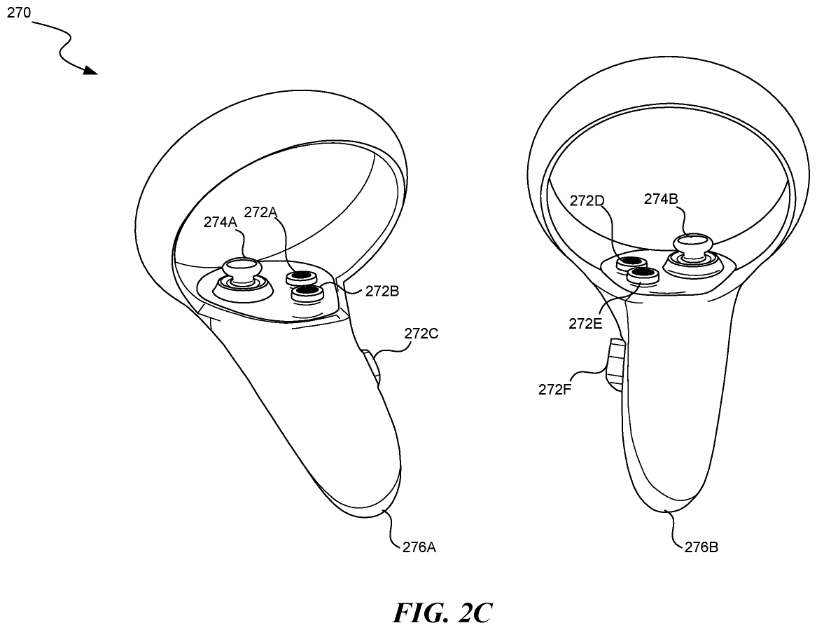

Several implementations are discussed below in more detail in reference to the figures. FIG. 1 is a block diagram illustrating an overview of devices on which some implementations of the disclosed technology can operate. The devices can comprise hardware components of a computing system 100 that can provide assisted scene capture for an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, assisted scene capture system 164, and other application programs 166. Memory 150 can also include data memory 170 that can include, e.g., artificial reality (XR) space model data, real-world space data, image data, scanning data, mesh data, rendering data, mesh analysis data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

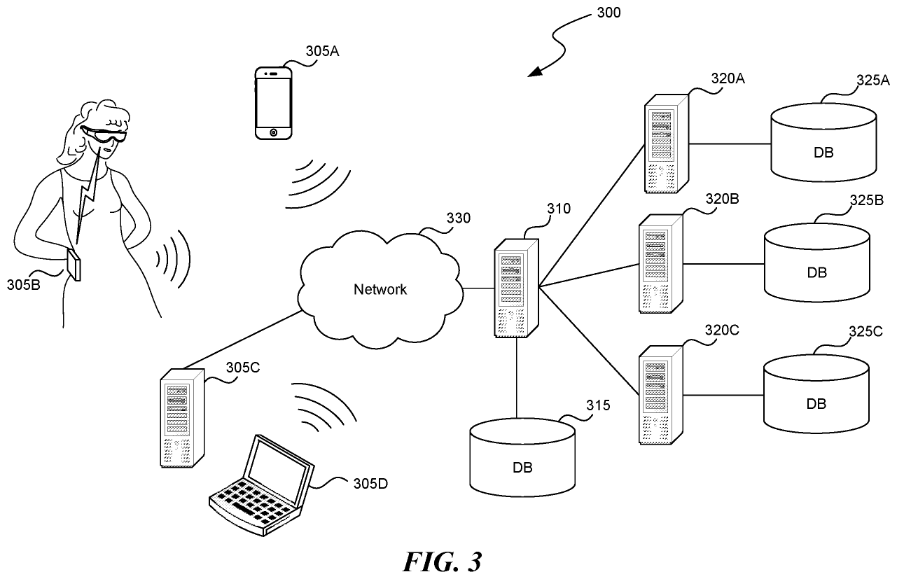

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

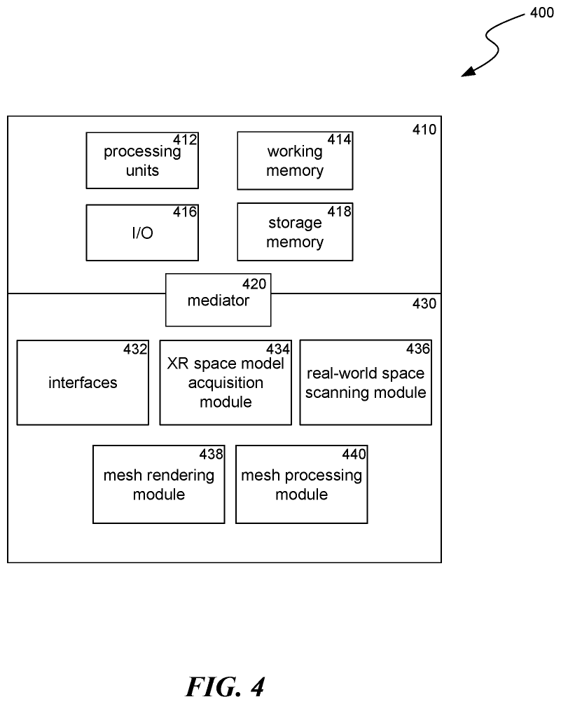

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

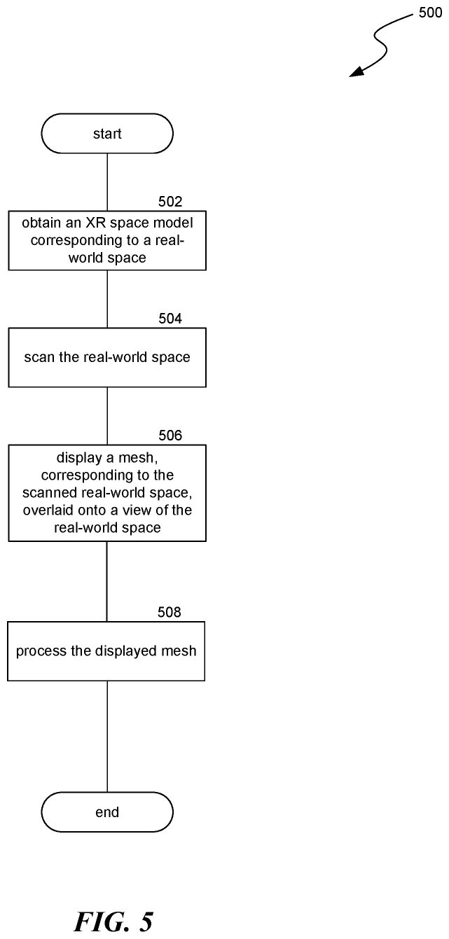

Specialized components 430 can include software or hardware configured to perform operations for providing assisted scene capture for an artificial reality (XR) environment. Specialized components 430 can include XR space model acquisition module 434, real-world space scanning module 436, mesh rendering module 438, mesh processing module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications. In some implementations, specialized components 430 can perform process 500 of FIG. 5 herein. In some implementations, specialized components 430 can be included in assisted scene capture system 164 of FIG. 1.

XR space model acquisition module 434 can obtain an XR space model (referred to interchangeably herein as a “room box”) corresponding to a real-world space. In some implementations, the real-world space can be a real-world room, such as within a home, an office, etc. The real-world room can include at least one of A) one or more physical walls, B) a floor, C) a ceiling, or any combination thereof. The XR space model can include corresponding A) one or more XR walls, B) an XR floor, C) an XR ceiling, or any combination thereof.

In some implementations, XR space model acquisition module 434 can obtain the XR space model by capturing the real-world space, e.g., using one or more cameras and/or one or more depth sensors included in input/output devices 416, which may be presented to the user for verification and/or modification. In some implementations, XR space model acquisition module 434 can capture the XR space model automatically, e.g., by automatically identifying the physical walls, floor, and/or ceiling using object recognition techniques, by analyzing color and/or depth data to identify continuous planes, etc. In some implementations, XR space model acquisition module 434 can prompt a user to manually capture the XR space model, e.g., by placing a controller (e.g., controller 276A and/or controller 276B of FIG. 2C) on the floor, by outlining the walls and/or ceiling, etc. In some implementations, XR space model acquisition module 434 can obtain a previously captured XR space model corresponding to the real-world space, such as from local storage or from a cloud. Further details regarding obtaining an XR space model corresponding to a real-world space are described herein with respect to block 502 of FIG. 5.

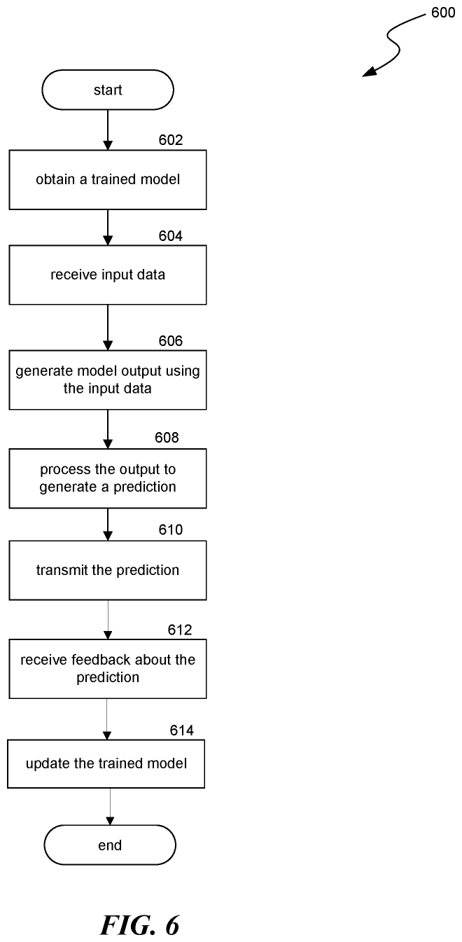

Real-world space scanning module 436 can scan the real-world space surrounding a user, the real-world space corresponding to the XR space model obtained by XR space model acquisition module 434. In some implementations, real-world space scanning module 436 can scan the real-world space using one or more cameras and/or one or more depth sensors included in input/output devices 416 while the user is moving about and/or looking around the real-world space. In some implementations, real-world space scanning module 436 can scan the real-world space without using one or more depth sensors, and can instead apply machine learning systems to estimate depth data corresponding to the 2D images captured by the one or more cameras. Further details regarding predicting depth data for a 2D image are described herein with respect to FIG. 6. Further details regarding scanning a real-world space are described herein with respect to block 504 of FIG. 5.

Mesh rendering module 438 can display a mesh, corresponding to the real-world space scanned by real-world space scanning module 436, overlaid onto a view of the real-world space. For example, while real-world space scanning module 436 is scanning the real-world space, mesh rendering module 438 can simultaneously, in real-time or near real-time, display the mesh on the real-world space. In some implementations, mesh rendering module 438 can additionally display a graphical user interface element with a message prompting the user to continue scanning the real-world space until the mesh is determined to be complete by mesh processing module 440, as described further herein. Further details regarding displaying a mesh, corresponding to a scanned real-world space, overlaid onto a view of the real-world space are described herein with respect to block 506 of FIG. 5.

Mesh processing module 440 can process the mesh displayed by mesh rendering module 438. In some implementations, mesh processing module 440 can edit the mesh based on user input received via input/output devices 416. For example, a user can use one or more controllers to drag, scale, and/or reposition the mesh to correspond to the flat surfaces (e.g., walls, floor, ceiling, etc.) and/or physical objects where their depth, size, shape, etc. was incorrectly scanned by real-world space scanning module 436. Further details regarding editing a mesh based on user input are described herein with respect to block 508 of FIG. 5.

In some implementations, mesh processing module 440 can collapse one or more variations in the mesh corresponding to a flat surface onto the XR space model obtained by XR space model acquisition module 434. For example, the flat surface scanned by real-world space scanning module 436 can include minor non-planar variations, such as nicks, nails, holes, small objects, etc., which can be deemed negligible (e.g., smaller than a threshold size, e.g., smaller then 1% of the surface, smaller than an inch, etc.). In another example, real-world space scanning module 436 can incorrectly detect variations in a flat surface that are not physically present (e.g., due to shadows, incorrectly estimated depth data, etc.). In such examples, mesh processing module 440 can edit the mesh to correspond to the XR space model where the minor variations are present, as the minor variations may affect user experience when the mesh is utilized by an XR application. Further details regarding collapsing one or more variations in a mesh corresponding to a flat surface onto an XR space model are described herein with respect to block 508 of FIG. 5.

In some implementations, mesh processing module 440 can clip the mesh to the XR space model, obtained by XR space model acquisition module 434, where the mesh extends beyond the XR space model. For example, when real-world space scanning module 436 scans the real-world space, it may “see through” windows and other glass elements, open doorways, open floor plans flowing through multiple rooms, etc., thus extending the mesh beyond the XR space model. In these examples, mesh processing module 440 can clip the mesh to the XR space model, such that the mesh does not extend beyond windows, doorways, etc. Further details regarding clipping a mesh to an XR space model where the mesh extends beyond the XR space model are described herein with respect to block 508 of FIG. 5.

In some implementations, mesh processing module 440 can simplify the mesh corresponding to an XR flat surface (e.g., one or more XR walls, the XR floor, and/or the XR ceiling). For example, because the flat surface has less detail than physical objects in the real-world space, mesh processing module 440 can remove detail from the mesh corresponding to the flat surface. Mesh processing module 440 can simplify the mesh by, for example, reducing the number of polygons representing the flat surface in the mesh. Further details regarding simplifying a mesh corresponding to an XR flat surface are described herein with respect to block 508 of FIG. 5.

In some implementations, mesh processing module 440 can determine that the mesh is complete by identifying that a threshold percentage of the XR space model is covered by the mesh. For example, mesh processing module 440 can compare the mesh for the real-world space, scanned by real-world space scanning module 436, to the XR space model obtained by XR space model acquisition module 434, and determine a percentage of completion relative to the XR space model. If the percentage is below a threshold (e.g., 75%, 85%, 90%, etc.), mesh rendering module 438 can display a graphical user interface element prompting the user to continue moving about and/or looking around the real-world space. If the percentage is at or above the threshold, mesh processing module 440 can determine that the mesh is complete. In some implementations, mesh rendering module 438 can then display a graphical user interface element indicating that the mesh is complete. Further details regarding determining that a mesh is complete by identifying that a threshold percentage of an XR space model is covered by the mesh are described herein with respect to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing assisted scene capture for an artificial reality (XR) environment. In some implementations, process 500 can be performed as a response to activation or donning of an XR device in a real-world space, such as the first time the XR device is used in the real-world space. In some implementations, process 500 can be performed as a response to a system-or application-level request to generate a mesh for a real-world space. In some implementations, process 500 can be performed by an XR system, which, in some implementations, can include one or more XR devices, such as an XR HMD (e.g., XR HMD 200 of FIG. 2A and/or XR HMD 252 of FIG. 2B), one or more controllers (e.g., controllers 276A and/or 276B of FIG. 2C), one or more external processing components, etc. In some implementations, process 500 can be performed solely by an XR HMD. In some implementations, process 500 can be performed by assisted scene capture system 164 of FIG. 1.

At block 502, process 500 can obtain an XR space model (referred to interchangeably herein as a “room box”), the XR space model corresponding to a real-world space (e.g., a real-world room). In some implementations, the real-world space can comprise at least one of a physical wall, a physical ceiling, a physical floor, or any combination thereof. In some implementations, the XR space model can comprise at least one of an XR wall corresponding to the physical wall, an XR ceiling corresponding to the physical ceiling, an XR floor corresponding to the physical floor, or any combination thereof.

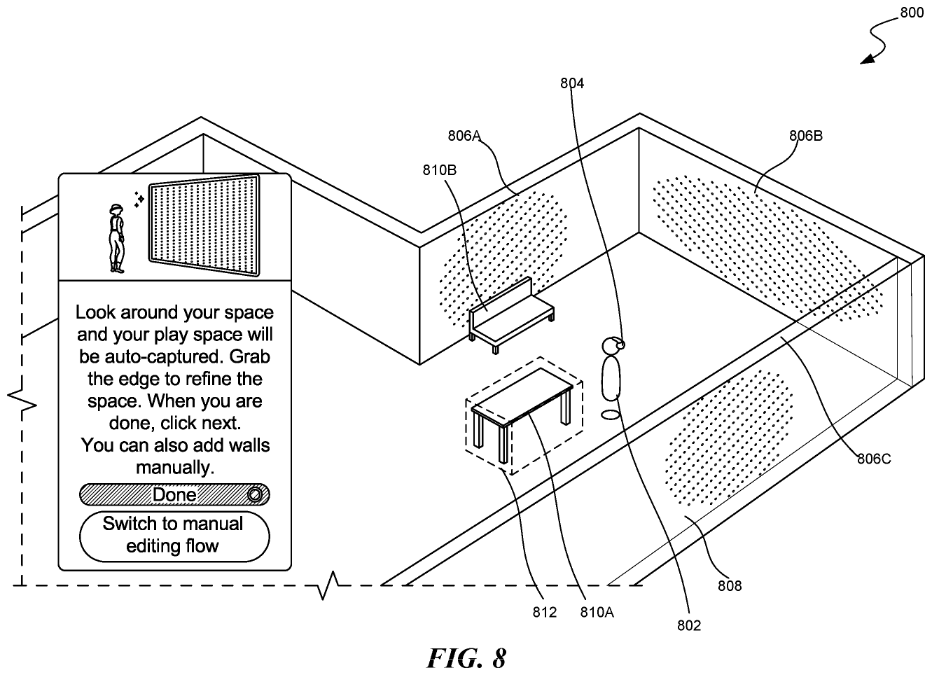

In some implementations, process 500 can obtain the XR space model automatically. For example, a user of an XR device can scan the real-world space using one or more cameras and/or one or more depth sensors by moving and/or looking around the real-world space with the XR device, and automatically identify one or more flat surfaces (e.g., walls, floor ceiling) in the real-world space using such image and/or depth data. For example, process 500 can identify the flat surfaces by analyzing the image and/or depth data for large areas of the same color, of consistently increasing and/or decreasing depth relative to the XR device, and/or of particular orientations (e.g., above, below, or around the XR device), etc. An example conceptual diagram of an XR device obtaining an XR space model automatically is shown and described herein with respect to FIG. 8.

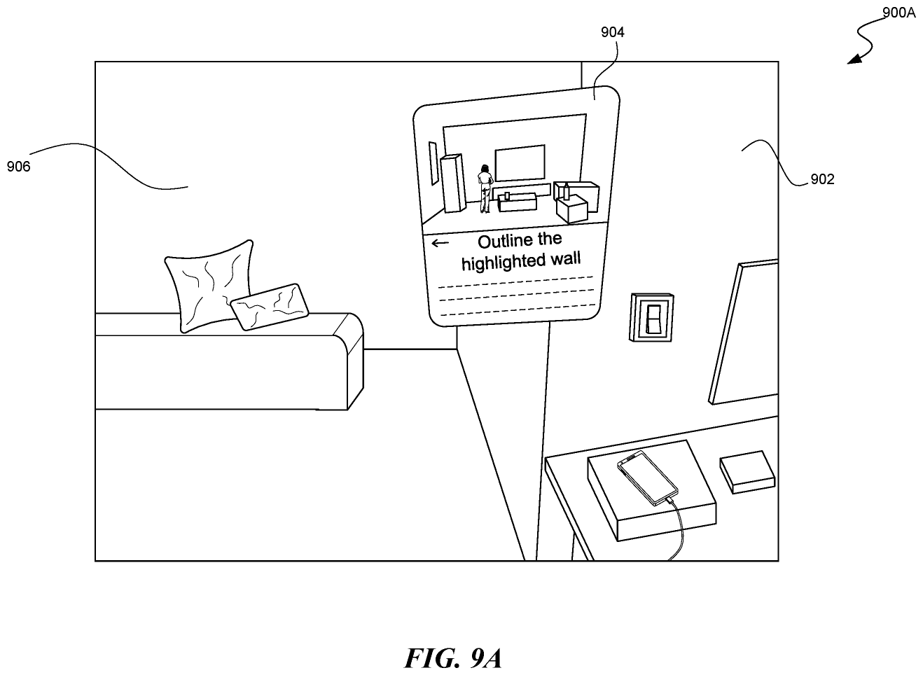

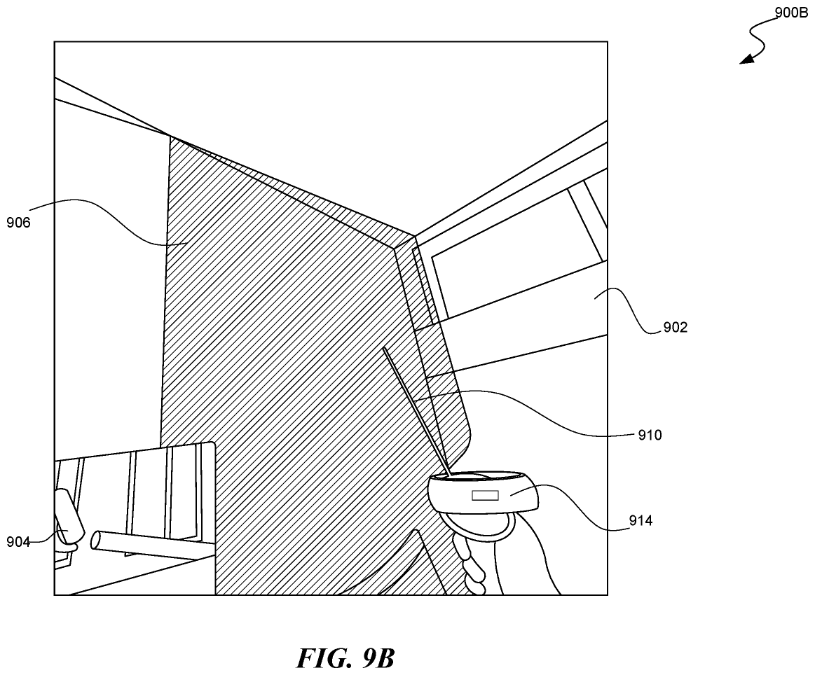

In some implementations, process 500 can capture the XR space model, at least in part, via detected positions of one or more controllers (e.g., controller 276A and/or controller 276B of FIG. 2C) and/or tracked hand or other body part positions. For example, the user of the XR system can move the controllers or body parts around the real-world space to, for example, outline the walls, ceiling, and/or floor with a ray projected from a controller. In another example, the user of the XR system can set the controller or body parts on the walls, ceiling, and/or floor to identify them based on the position of the controller or body part (e.g., as detected by one or more cameras on the XR device, as detected via one or more sensors of an IMU, etc.). In some implementations, process 500 can automatically capture the XR space model, which can then be refined (if necessary) via one or more controllers or body parts as described further herein. Further details regarding capturing and realigning an XR space model are described in U.S. patent application Ser. No. 18/346,379, filed Jul. 3, 2023, entitled “ARTIFICIAL REALITY ROOM CAPTURE REALIGNMENT,” which is herein incorporated by reference in its entirety. An exemplary view from an XR device capturing an XR space model via a controller is shown and described herein with respect to FIGS. 9A-9B.

In some implementations, process 500 need not capture the XR space model, and can obtain a previously captured XR space model. For example, process 500 can locally obtain an XR space model that was previously captured by the XR system. In another example, process 500 can obtain an XR space model that was previously captured by another XR system corresponding to the same real-world space. In some implementations, process 500 can obtain a previously captured XR space model over a network (e.g., network 330 of FIG. 3), either from another XR system or from a cloud.

In some implementations, the XR space model can include XR objects corresponding to captured physical objects within the real-world space. For example, upon capturing the real-world space, process 500 can automatically detect physical objects separate from the walls, ceiling, and/or floor. In some implementations, process 500 can automatically display a bounding box surrounding the physical objects, and allow the user to select the type of physical object from a list (e.g., sofa, table, chair, etc.) in order to label a corresponding XR object. In some implementations, however, it is contemplated that process 500 can automatically detect the type of physical object (e.g., by applying object recognition techniques to an image of the physical object captured by the XR system), and can automatically add a corresponding XR object to the XR space model.

At block 504, process 500 can scan the real-world space surrounding a user of the XR system. In some implementations, process 500 can scan the real-world space using at least one or more or more cameras, one or more depth sensors, or any combination thereof. In some implementations, process 500 can scan the real-world space using one or more cameras, without the use of depth sensors, capturing one or more two-dimensional (2D) images of the real-world space without corresponding depth data, which can later be predicted, as described further herein.

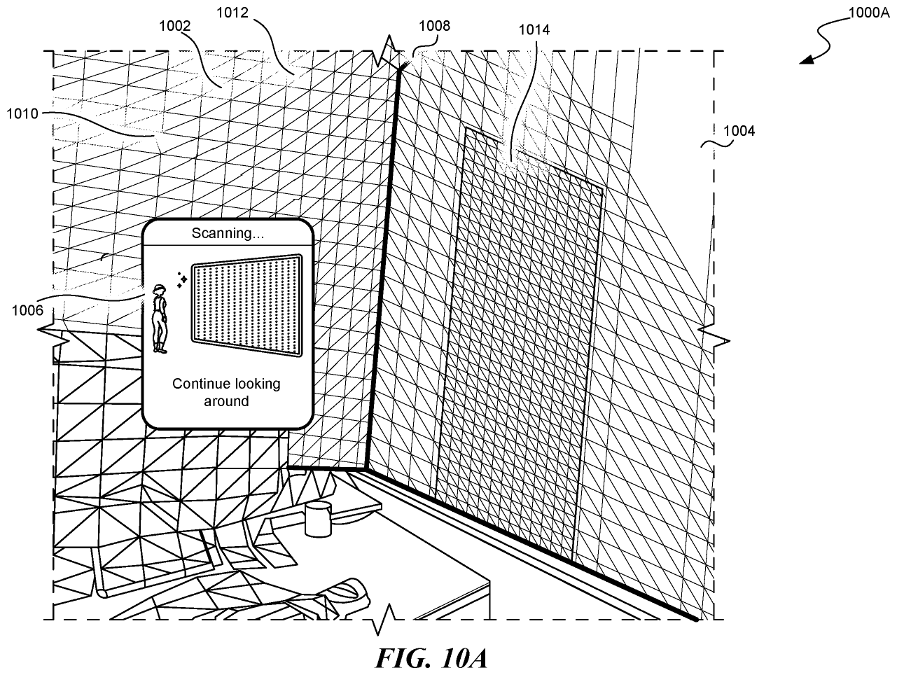

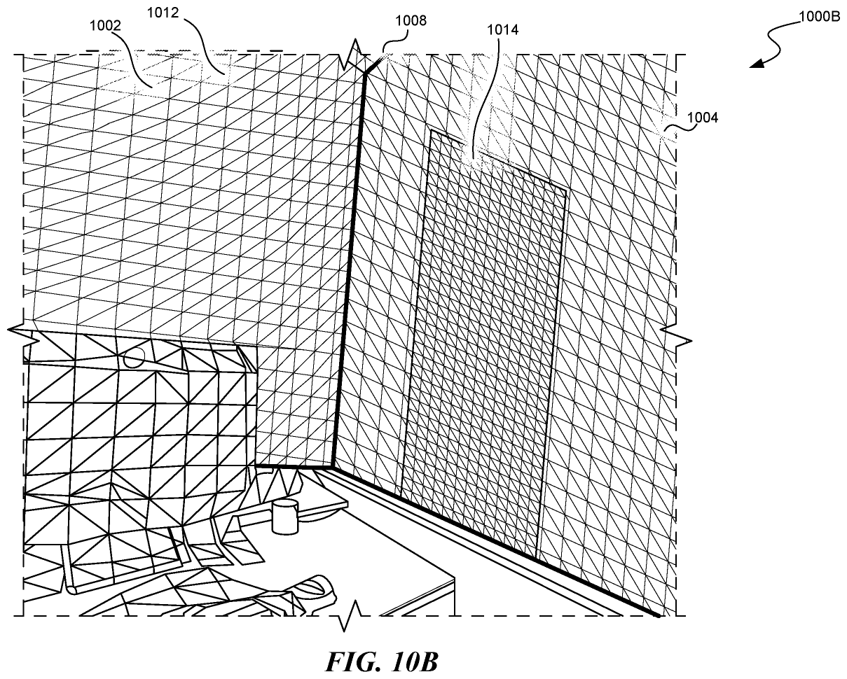

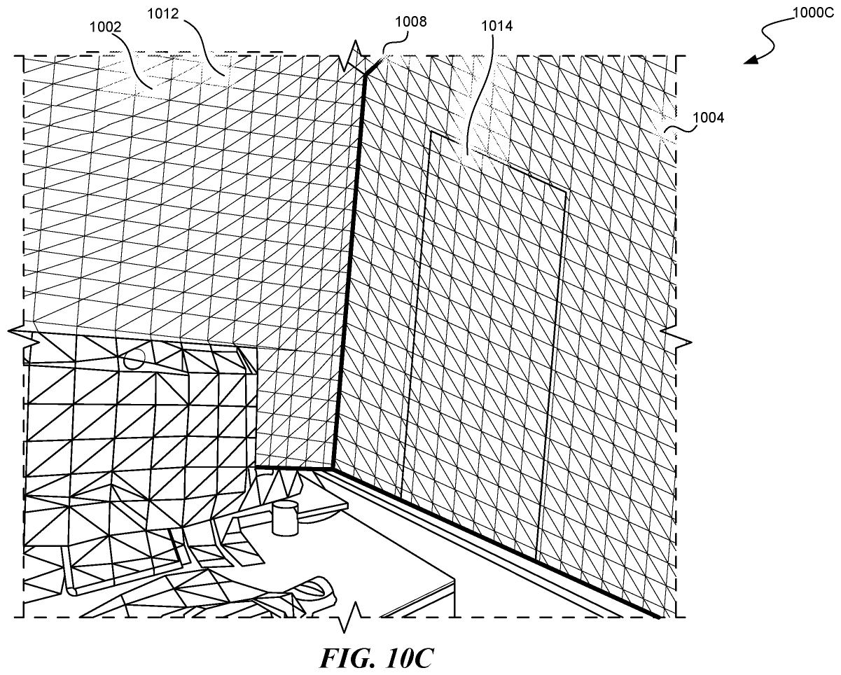

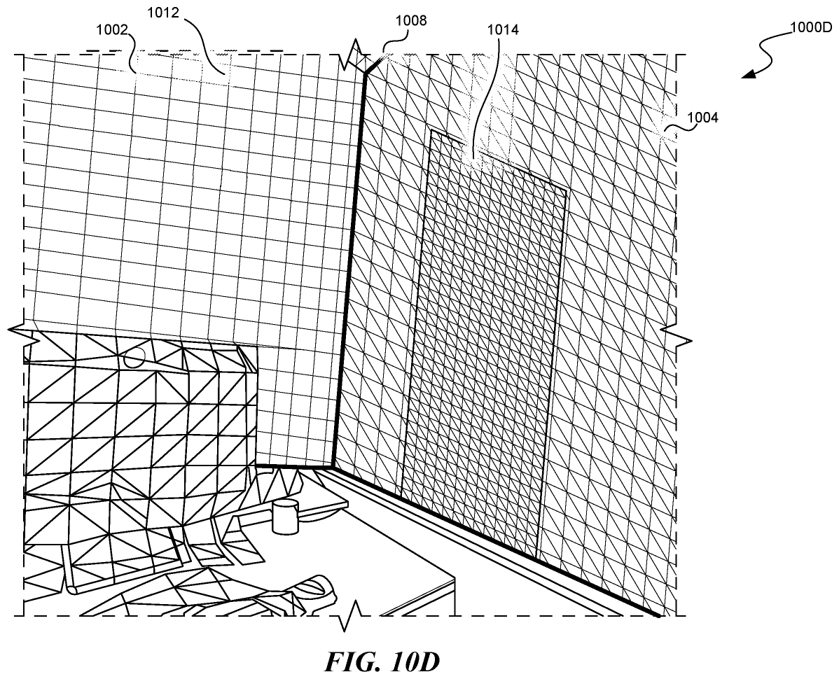

At block 506, process 500 can display a mesh, corresponding to the scanned real-world space, overlaid onto a view of the real-world space. In some implementations, the mesh can include, for example, a grid of one or more interconnected shapes (e.g., squares, triangles, etc.). An exemplary view of a mesh is shown and described herein with respect to FIG. 10A.

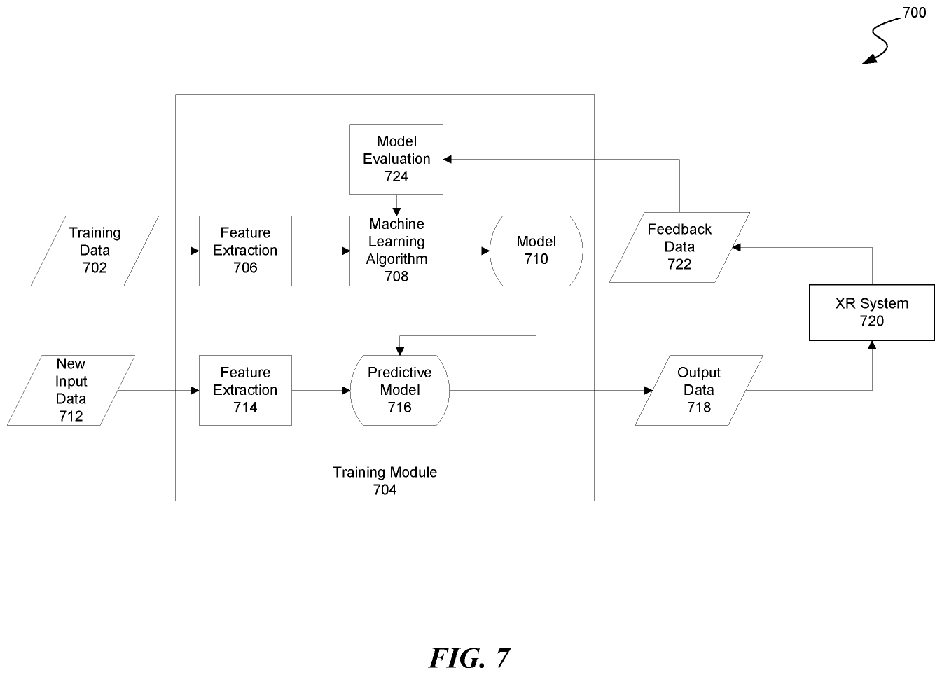

In some implementations, process 500 can generate the mesh by estimating depth data for the scanned real-world space, e.g., when depth data is not captured or otherwise available. In such implementations, process 500 can estimate depth data corresponding to the 2D images captured by the one or more cameras by applying machine learning techniques. Further details regarding applying machine learning models to estimate depth data from 2D images are described herein with respect to FIGS. 6 and 7.

At block 508, process 500 can apply further processing to the displayed mesh. In some implementations, processing the displayed mesh can include adjusting the mesh based on user input. For example, if a portion of the displayed mesh does not align with the real-world space, the user of the XR system can realign the mesh with the real-world space by one or more methods. In one example, the user can use her hand and/or a controller to manually select the incorrect portion of the mesh and drag it to align with the real-world space. In another example, the user can use a controller to touch the real-world space corresponding to the incorrect portion of the mesh, and the XR system can determine a correct location of the mesh based on the detected position of the controller.

In some implementations, processing the displayed mesh can include collapsing one or more variations in the mesh corresponding to a flat surface (e.g., a physical wall, a physical ceiling, a physical floor, or any combination thereof), onto the XR space model. For example, when scanning the real-world space, process 500 may incorrectly detect minor discrepancies in the depth of the walls, ceiling, and/or floor, causing the mesh to not lay flat on the surface. In such examples, process 500 can collapse the mesh onto the corresponding XR flat surface of the XR space model, such that the mesh lays flat without the minor variations in depth. Thus, when an XR application applying the mesh renders a virtual object interacting with the real-world space, the virtual object can be correctly placed relative to the real-world flat surfaces, without the errors in depth. An exemplary view of a mesh that has been collapsed to an XR space model is shown and described herein with respect to FIG. 10B.

In some implementations, processing the displayed mesh can include clipping the mesh to the XR space model where the mesh extends beyond the XR space model. For example, when scanning the real-world space, process 500 may detect depth beyond windows, sliding glass doors, open doorways, and/or other see-through elements of a real-world space. In such examples, process 500 can modify the mesh to correspond to the XR space model, such that the mesh does not extend beyond the model. Thus, when an XR application applying the mesh renders a virtual object interacting with the real-world space, the virtual object does not move or extend beyond such see-through elements. An exemplary view of a mesh that has been clipped to an XR space model is shown and described herein with respect to FIG. 10C.

In some implementations, processing the displayed mesh can include simplifying the mesh corresponding to an XR flat surface (e.g., an XR wall, an XR ceiling, an XR floor, or any combination thereof). For example, because the surfaces are flat, a denser, higher definition mesh may not be necessary as fewer details are included on such surfaces. Thus, in such examples, process 500 can simplify the mesh by merging the mesh corresponding to the XR flat surfaces (e.g., merge 2 triangles into one square, merge all shapes corresponding to a flat surface into a rectangle, etc.). An exemplary view of a mesh that has been simplified is shown and described herein with respect to FIG. 10D.

In some implementations, processing the displayed mesh can include determining that the mesh is complete by identifying that a threshold percentage of the XR space model is covered by the mesh. For example, process 500 can compare the scanned portion of the real-world space to the XR space model to determine how much of the real-world space has been scanned and whether it exceeds a threshold, e.g., 90%. In such examples, process 500 can determine that the mesh is sufficiently complete and stop scanning the real-world space. In some implementations, process 500 can display a prompt to the user of the XR system indicating that the mesh is complete, and/or can remove a prompt indicating that the user should continue to scan the real-world space.

In some implementations, the processing can further include determining that at least one of one or more physical objects captured by the mesh is dynamic. Process 500 can determine that a physical object is dynamic by, for example, analyzing image data and/or depth data captured by the XR system to determine that the physical object is moving. In another example, process 500 can determine that a physical object is dynamic by performing object recognition on image data captured by the XR system (e.g., identifying a human, an animal, etc.). In such implementations in which process 500 determines that a physical object is dynamic, process 500 can filter the at least one of the one or more physical objects out of the mesh. For example, process 500 can remove the identified physical objects from the mesh. Thus, when an XR application applying the mesh renders a virtual object interacting with the real-world space, the virtual object will not interact with physical objects whose positions are likely to change.

In some implementations, process 500 can further provide at least one of the XR space model, the processed mesh, or both to an XR application executing on the XR system. In some implementations, the XR application can select to apply the XR space model and/or the mesh while executing and/or rendering virtual objects. In some implementations, the mesh can include one or more XR objects corresponding to one or more physical objects in the real-world space scanned by the XR system. In some implementations, process 500 can further include displaying a virtual object interacting with at least one of the one or more XR objects, the virtual object being provided by the XR application. For example, process 500 can display a virtual avatar sitting on a real-world couch. In some implementations, a virtual object in the XR application, executing on the XR system, can interact with the XR space model, the processed mesh, or both. For example, an XR application can render a ball bouncing off of the walls or other physical objects in the real-world space.

FIG. 6 is a flow diagram illustrating a process used in some implementations for locally applying and updating a trained model for generating depth predictions according to some implementations of the present technology. In some implementations, process 600 can be performed as a response to obtaining two-dimensional (2D) image data corresponding to a real-world space, without corresponding depth data and/or when additional depth data is needed. In some implementations, process 600 can be performed by an XR system, the XR system including one or more XR devices (e.g., an XR HMD, one or more controllers, and/or one or more external processing components). In some implementations, process 600 can be performed by assisted scene capture system 164.

At block 602, process 600 can receive a trained model. In some implementations, the received model can be initially trained on 2D images having corresponding depth maps. In some implementations, the depth maps can include known depth data captured by one or more depth sensors. In some implementations, the depth maps can include depth data predicted by the trained model and confirmed to be accurate, such as by a user. In some implementations, process 600 can receive an updated machine learning model, such as when process 600 is performed iteratively.

At block 604, process 600 can receive input data. In some implementations, the input data can include 2D monocular and/or stereo images of a real-world space. In some implementations, the input data can further include contextual factors surrounding the images. The contextual factors can include when the image was taken, where the image was taken, labeled scene data (e.g., walls, ceiling, floor, couch, table, etc.), position and/or orientation data, ambient lighting data, etc. For example, process 600 can capture and/or obtain the input data and/or contextual factors from one or more cameras, one or more sensors (e.g., in an inertial measurement unit (IMU)), from data storage (e.g., storing scene data, storing an XR space model, etc.), and/or the like.

At block 606, process 600 can generate a model output using the input data (e.g., the 2D monocular and/or stereo images) and the trained model. In some implementations, process 600 can further generate the model output using any contextual factors. In some implementations, based on the input data, process 600 can extract relevant features from the input data (e.g., pixel-by-pixel RGB data) and map the features as data points to an output vector in a classification space created using the training data.

At block 608, process 600 can process the model output to generate predicted depth data based, at least partially, on the input images. In some implementations, process 600 can generate a match score between the output (e.g., the mapped features of the input data) and the features of candidate depth data from the training images in the classification space by calculating a distance between the output and the candidate depth data (e.g., pixel-by-pixel and, in some implementations, taking into account groups of pixels and/or neighboring pixels). The match score can be any numerical or textual value or indicator, such as a statistic or percentage. Process 600 can identify the predicted depth data based on, for example, the candidate depth data having the highest match score to the output. Once pixel-by-pixel (or grouped pixel) depth data has been established, process 600 can generate a predicted depth map for the input images.

At block 610, process 600 can transmit the prediction. In some implementations, process 600 can output the predicted depth map in the form of a mesh overlaid on a view of a real-world space, as described further herein, and at block 612, process 600 can receive feedback about the predicted depth map. In some implementations, the feedback can be explicit. For example, upon display of the mesh on an XR system, the user can adjust the mesh to correct the predicted depth of the real-world space such that the mesh corresponds to the actual depth of the real-world space. In some implementations, the feedback can be implicit, i.e., the user fails to adjust the displayed mesh. The feedback can be provided by the same or different XR system than that capturing the images of the real-world space. For example, an XR system downloading the mesh from a cloud, previously captured by another XR system, can adjust or fail to adjust the downloaded mesh to correspond to the real-world space.

At block 614, process 600 can update the trained model. For example, process 600 can use the feedback data to identify whether the predicted depth map (displayed as the mesh) was correct or incorrect (and, if incorrect, what the correct depth map was), and use that information as a comparison factor to update the model and/or the classification space. In some implementations, process 600 can weigh the current training data more heavily than the initial or past training data, as the later training data can be considered more relevant and/or accurate. Although illustrated as a single process 600 in FIG. 6, it is contemplated that process 600 can be performed multiple times and/or repeatedly, either consecutively or concurrently, as additional input data is received.

Some implementations of the assisted scene capture system can include a machine learning component, such as a neural network, that is trained using a variety of data, including known input data, contextual factors, and whether the predicted depth map was correct or incorrect. Some implementations can feed input data including one or more 2D images and any contextual factors into the trained machine learning component, and based on the output, can generate a predicted depth map. Some implementations provide this predicted depth map to a user via a graphical user interface on a display, such as via a displayed mesh overlaid on the captured real-world space. Some implementations receive feedback about the predicted depth map to further enhance the trained model.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the trained model can be a neural network with multiple input nodes that receive input data including one or more 2D images of a real-world space and any contextual factors. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,”) one or more nodes can produce a value classifying the input that, once the model is trained, can be used to predict a depth map corresponding to the 2D images. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes known input data and any contextual factors and a desired output, such as a predicted depth map. Current input data (e.g., one or more 2D images of a real-world space) can be provided to the model. Output from the model can be compared to the desired output for that input data, and, based on the comparison, the model can be modified, such as by changing weights between nodes of the neural network or parameters of the functions used at each node in the neural network (e.g., applying a loss function). After applying each of the factors in the training data and modifying the model in this manner, the model can be trained to evaluate new input data.

Some implementations of the assisted scene capture system can include a deep learning component. A “deep learning model,” as used herein, refers to a construct trained to learn by example to perform classification directly from input data. The deep learning model is trained by using a large set of labeled data and applying a neural network as described above that includes many layers. The deep learning model in some implementations can be a convolutional neural network (CNN) that is used to automatically learn input data's inherent features to identify a predicted action. For example, the deep learning model can be an R-CNN, Fast R-CNN, or Faster-RCNN.

FIG. 7 is a block diagram illustrating an overview of a machine learning system that can be applied to generate depth predictions according to some implementations of the present technology. In a training phase, system 700 can feed raw training data 702 (e.g., 2D images having corresponding depth maps) into feature extraction 706 of training module 704 to select useful features (e.g., pixel data, neighboring pixel data, RGB data, etc.) from all available features. As described further herein with respect to FIG. 6, the contextual factors can include any additional data surrounding the 2D images, such as when and where the 2D image was taken, objects within the 2D images, ambient lighting, etc., and can be obtained using any suitable method.

System 700 can feed the extracted features to machine learning algorithm 708. Machine learning algorithm 708 can identify a model 710 that maps the 2D training images and any contextual factors to predicted depth maps, and uses past feedback to identify whether the predictions were correct. In some implementations, model 710 can be a neural network. System 700 can repeat the training phase until a suitable accuracy level is reached, e.g., as identified by applying a loss function, such as when a sufficient amount of training data 702 has been processed and predictions made by model 710 do not deviate too far from actual results. As appreciated by one skilled in the art, if model 710 is a deep learning model, a large amount of training data may be needed to make accurate predictions.

In a predicting phase, system 700 can feed new input data 712 into feature extraction 714 of training module 704 to select useful features. System 700 can apply a predictive model 716 to the extracted features based on the trained model 710 to generate output data 718 (e.g., a predicted depth map). System 700 can output or write data 718 to XR system 720. In some implementations, the user of XR system 720 can provide feedback data 722 to training module 704 via XR system 720, such as feedback regarding whether the predicted depth map was correct or incorrect, and if incorrect, what the correct depth map was.

System 700 can input the feedback data 722 into model evaluation 724 to restart the training phase. Model evaluation 724 can evaluate predictive model 716 with metrics, for example. The metrics can include accuracy, precision, F1 score, Mean Squared Error, etc. System 700 can feed these metrics back into machine learning algorithm 708 to refine and update model 710, if necessary, and the predicting phase can be repeated.

FIG. 8 is a conceptual diagram illustrating an exemplary real-world space 800 being automatically scanned to generate a room box (referred to interchangeably herein as an “XR space model”) according to some implementations of the present technology. In some implementations, user 802 of XR device 804 can move about real-world space 800 and/or look around while wearing XR device 804, and XR device 804 can automatically scan real-world space 800 for flat surfaces (e.g., walls 806A-806C, floor 808, and/or ceiling (not shown)). In some implementations, user 802 can confirm the location of floor 808 by placing a controller (not shown) on floor 808. In some implementations, XR device 804 can display an indicator of the position of walls 806A-806C (e.g., highlighting, outlining, etc.). User 802 can then manually edit the positions of walls 806A-806C if necessary, such as by pointing and dragging the walls using a controller, as is described further herein.

In some implementations, XR device 804 can further automatically detect physical objects 810A-810B in real-world space 800. For example, upon detection of physical object 810A, XR device 804 can display bounding box 812 surrounding physical object 810A, and prompt user 802 to select a type of physical object 810A (e.g., a table) (not shown). In another example, user 802 can manually select (e.g., by pointing and clicking or outlining) physical object 810B and enter a type of physical object 810B, without automatic detection by XR device 804. Although described primarily herein as using controllers to perform such steps, it is contemplated that some implementations can alternatively or additionally use hand, gaze, and/or gesture detection to produce similar results.

FIG. 9A illustrates an exemplary view 900A on an artificial reality (XR) device of an XR overlay 904 instructing a user to outline a wall 906 in a real-world space 902 in order to generate a room box (referred to interchangeably herein as an “XR space model”). For example, upon activation or donning of the XR device in real-world space 902, the XR device can, in some implementations, determine whether the room box was previously captured. The XR device can determine whether the room box was previously captured by first determining a location of the XR device, e.g., by using geolocation, by analyzing visual features of real-world space 902, by accessing stored spatial anchors for real-world space 902, etc. The XR device can then query local storage and/or a cloud for a previously generated room box. If the room box is not preexisting, the XR device can display XR overlay 904 prompting the user to outline wall 906.

FIG. 9B illustrates an exemplary view 900B on an artificial reality (XR) device of a user outlining a wall in a real-world space 902 using controller 914 in order to generate a room box (referred to herein interchangeably as an “XR space model”). In some implementations, controller 914 can be similar to controller 276A and/or controller 276B of FIG. 2C. In some implementations, virtual ray 910 cast from the XR device corresponding to controller 914 can be used to outline wall 906. In one example, first the height of wall 906 can be captured by moving ray 910 from top to bottom, edge to edge (or vice versa), and then the width by moving ray 910 from left to right (or vice versa). In some implementations, before annotating the actual wall 906, the user can first calibrate by placing controller 914 on the floor and clicking one of the buttons in order to confirm the floor level.

In some implementations, cameras within the XR system that execute plane detection algorithms can be used to capture the highlighted real-world wall 906 for artificial reality. These cameras can use computer vision techniques to detect and analyze planes, which are flat surfaces like walls and floors, in real-time. In some implementations, the cameras can include one or more depth-sensing cameras that can capture 3D data of a room in real-time using a technique called SLAM (Simultaneous Localization and Mapping). The camera can detect planes and create a 3D map of the environment by tracking its own movement and combining it with the depth data captured by the camera.

After wall 906 is successfully marked or captured, the remaining walls (including floor and ceiling in some implementations) and objects in the room can be outlined. In some implementations, the XR space model and real-world space 902 can then be automatically realigned. In some implementations, SLAM-based tracking can be used for the realignment, which involves using a depth-sensing camera or other sensors to create a 3D map of real-world space 902 and track the position and orientation of the camera in real-time. The data from the sensors can then be used to realign the XR space model with real-world space 902. In some implementations, inertial-based tracking can be used for the realignment, which involves using IMUs or other sensors to track the position and orientation of the user's head or body in real-time. The data from the sensors can then be used and calibrated to update the position and orientation of the XR space model to match real-world space 902.

Some implementations can further provide functionality to adjust room placement that can be entered after wall 906 is successfully marked in accordance with some implementations if an automatic re-alignment is not adequate. A user can be instructed to move controller 914 to shift the placement of the whole XR space model until it is aligned with the outlined walls and objects. At that point, the entire space can be successfully realigned. The user can drag the XR space model, using controller 914, in free space which moves it around translationally or rotationally.

FIG. 10A illustrates an exemplary view 1000A on an artificial reality (XR) device of a mesh 1002 being displayed as the XR device scans a real-world space 1004. While the XR device is scanning real-world space 1004, the XR device can display an XR overlay 1006 prompting the user to continue moving about real-world space 1004, and/or to continue looking around real-world space 1004, in order to generate mesh 1002. In some implementations, the XR device can post-process mesh 1002 upon completion, e.g., when a threshold amount of room box 1008 (referred to interchangeably herein as an “XR space model”) has been covered by mesh 1002.

FIG. 10B illustrates an exemplary view 1000B on an artificial reality (XR) device of a mesh 1002 being collapsed to a room box 1008 in post-processing based on a minor variation 1010 in the mesh 1002. Variation 1010 in mesh 1002 is shown in pre-processed mesh 1002 of FIG. 10A. In post-processing, the XR device can analyze the flat surfaces indicated by mesh 1002 for variations or inconsistencies relative to the flat surfaces of room box 1008, and identify variation 1010 in mesh 1002. The XR device can then collapse mesh 1002 to room box 1008 for that flat surface (i.e., wall 1012) to eliminate errors in mesh 1002 and/or to disregard small, insignificant physical variations or objects on wall 1012, thus simplifying mesh 1002. Such simplification of mesh 1002 can result in less storage space needed to store mesh 1002 (locally and/or on a cloud), and improved latency and reduced processing power needed to apply mesh 1002 in XR experiences and XR applications, as described further herein.

FIG. 10C illustrates an exemplary view 1000C on an artificial reality (XR) device of a mesh 1002, extending into an open doorway 1014, being clipped to a room box 1008 in post-processing. Mesh 1002 extending into open doorway 1014 is shown in pre-processed mesh 1002 of FIG. 10A. In post-processing, the XR device can analyze mesh 1002 relative to room box 1008 to determine that mesh 1002 extends beyond room box 1008 in open doorway 1014. Alternatively or additionally, in some implementations, the XR device can perform object recognition to recognize open doorway 1014 and identify its corresponding mesh 1002. Although illustrated as extending beyond open doorway 1014 in FIG. 10A, it is contemplated that mesh 1002 can similarly extend beyond room box 1008 in windows, glass doors, open spaces not fully enclosed (e.g., in an open floor plan, in a loft, etc.), and/or the like.

Upon determining that mesh 1002 extends beyond room box 1008 in open doorway 1014 (and/or upon identifying open doorway 1014 and its corresponding mesh 1002), the XR device can clip mesh 1002 to room box 1008 for open doorway 1014, as shown in view 1000C. Such clipping can reduce the size of mesh 1002, resulting in less storage space needed, and improved latency and processing when applied by XR experiences and XR applications. Further, clipping mesh 1002 as shown in FIG. 10C can result in an improved, more realistic user experience. For example, if an XR application renders a virtual ball bouncing around a real-world room, the virtual ball would appear to bounce off of a real-world window based on the clipped mesh, instead of appearing to bounce through the window.

FIG. 10D illustrates an exemplary view on an artificial reality (XR) device of a mesh 1002 being simplified where it corresponds to the identified flat surfaces (e.g., wall 1012 in this example) in a real-world space 1004. Mesh 1002 is shown in a full level of detail when scanned in view 1000A of FIG. 10A. In post-processing, the XR device can identify wall 1012 as a flat surface needing a lesser amount of detail in mesh 1002. The XR device can identify wall 1012 as a flat surface using any of the methods described herein. The XR device can then simplify mesh 1002 for wall 1012, e.g., by reducing the number of polygons within mesh 1002 for wall 1012. Such simplification of mesh 1002 can result in less storage space needed to store mesh 1002 (locally and/or on a cloud), and improved latency and reduced processing power needed to apply mesh 1002 in XR experiences and XR applications, as described further herein. Such improvements can be realized without affecting the user experience.

Although illustrated separately in FIGS. 10B-10D, it is contemplated that any combination of the described post-processing techniques can be applied to mesh 1002 of FIG. 10A, and/or that all of the described post-processing techniques can be applied to mesh 1002 of FIG. 10A (not shown). Further, although shown and described in FIGS. 10B-10D as being displayed as a view on an XR device, it is contemplated that any combination of the described post-processing techniques can be applied to mesh 1002 without displaying the corresponding changes to a user. The post-processed mesh can then be used by XR applications in rendering XR experiences.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations exclusive mutually of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for providing assisted scene capture for an artificial reality environment, the method comprising:
obtaining an artificial reality space model corresponding to a real-world space,
wherein the real-world space comprises at least one of a physical wall, a physical ceiling, a physical floor, or any combination thereof, and
wherein the artificial reality space model comprises at least one of an artificial reality wall corresponding to the physical wall, an artificial reality ceiling corresponding to the physical ceiling, an artificial reality floor corresponding to the physical floor, or any combination thereof;
scanning, via an artificial reality system, the real-world space, the real-world space surrounding a user of the artificial reality system;
displaying a mesh, corresponding to the scanned real-world space, overlaid onto a view of the real-world space; and
processing the mesh, the processing including at least one of:
collapsing one or more variations in the mesh corresponding to the at least one of the physical wall, the physical ceiling, the physical floor, or any combination thereof, onto the artificial reality space model,
clipping the mesh to the artificial reality space model where the mesh extends beyond the artificial reality space model,
simplifying the mesh corresponding to the at least one of the artificial reality wall, the artificial reality ceiling, the artificial reality floor, or any combination thereof,
determining that the mesh is complete by identifying that a threshold percentage of the artificial reality space model is covered by the mesh, or
any combination thereof.

2. The method of claim 1, further comprising:
providing at least one of the artificial reality space model, the processed mesh, or both to an artificial reality application executing on the artificial reality system.

3. The method of claim 2, wherein a virtual object in the artificial reality application, executing on the artificial reality system, interacts with the at least one of the artificial reality space model, the processed mesh, or both.

4. The method of claim 1,
wherein the mesh includes one or more artificial reality objects corresponding to one or more physical objects in the scanned real-world space.

5. The method of claim 4, further comprising:
displaying a virtual object interacting with at least one of the one or more artificial reality objects, the virtual object being provided by the artificial reality application.

6. The method of claim 4, wherein the processing further includes:
determining that at least one of the one or more physical objects is dynamic; and
filtering the at least one of the one or more physical objects out of the mesh.

7. The method of claim 1, wherein the artificial reality space model is adjustable by the user via the artificial reality system.

8. The method of claim 1, wherein the mesh is adjustable by the user via the artificial reality system.

9. The method of claim 1, wherein the artificial reality system scans the real-world space using at least one of one or more cameras, one or more depth sensors, or any combination thereof.

10. The method of claim 1, wherein the artificial reality space model was captured, at least in part, via detected positions of one or more controllers of the artificial reality system.

11. The method of claim 1, wherein the artificial reality space model was captured, at least in part, by automatically identifying one or more flat surfaces in the real-world space.

12. The method of claim 1,
wherein the mesh is generated by estimating depth data for the scanned real-world space, and
wherein the depth data is estimated by applying a machine learning model to one or more images of the scanned real-world space.

13. A computer-readable storage medium storing instructions that, when executed by a computing system, cause the computing system to perform a process for providing assisted scene capture for an artificial reality environment, the process comprising:
obtaining an artificial reality space model corresponding to a real-world space, the real-world space comprising at least one physical flat surface, and the artificial reality space model comprising at least one artificial reality flat surface corresponding to the physical flat surface;
scanning, via an artificial reality system, the real-world space;
generating a mesh, corresponding to the scanned real-world space, overlaid onto a view of the real-world space; and
processing the mesh, the processing including at least one of:
collapsing one or more variations in the mesh corresponding to the at least one physical flat surface onto the corresponding artificial reality flat surface,
clipping the mesh to the artificial reality space model where the mesh extends beyond the artificial reality space model,
simplifying the mesh corresponding to the at least one artificial reality flat surface, or
any combination thereof.

14. The computer-readable storage medium of claim 13, wherein the processing further comprises:
determining that the mesh is complete by identifying that a threshold percentage of the artificial reality space model is covered by the mesh.

15. The computer-readable storage medium of claim 13, wherein the process further comprises:
providing at least one of the artificial reality space model, the processed mesh, or both to an artificial reality application executing on the artificial reality system.

16. The computer-readable storage medium of claim 15, wherein a virtual object in the artificial reality application, executing on the artificial reality system, interacts with the at least one of the artificial reality space mode, the processed mesh, or both.

17. A computing system for providing assisted scene capture for an artificial reality environment, the computing system comprising:
one or more processors; and
one or more memories storing instructions that, when executed by the one or more processors, cause the computing system to perform a process comprising:
obtaining an artificial reality space model corresponding to a real-world space, the real-world space comprising at least one physical flat surface, and the artificial reality space model comprising at least one artificial reality flat surface corresponding to the physical flat surface;
scanning, via an artificial reality system, the real-world space;
generating a mesh, corresponding to the scanned real-world space, overlaid onto a view of the real-world space; and
processing the mesh, the processing including at least one of:
collapsing one or more variations in the mesh corresponding to the at least one physical flat surface onto the corresponding artificial reality flat surface,
clipping the mesh to the artificial reality space model where the mesh extends beyond the artificial reality space model,
simplifying the mesh corresponding to the at least one artificial reality flat surface, or
any combination thereof.

18. The computing system of claim 17, wherein the processing further comprises:
determining that the mesh is complete by identifying that a threshold percentage of the artificial reality space model is covered by the mesh.

19. The computing system of claim 18,
wherein the mesh includes one or more artificial reality objects corresponding to one or more physical objects in the scanned real-world space.

20. The computing system of claim 19, wherein the processing further includes:
determining that at least one of the one or more physical objects is dynamic; and
filtering the at least one of the one or more physical objects out of the mesh.
